(19) United States
(12) Patent Application Publication
(10) Pub. No.: US 2006/0171273 A1
(43) Pub. Date: Aug. 3, 2006

(54) Method for compensating frequency response of an actuator in an optical disc drive

(75) Inventors: Chang-Der Liu, Hsin-Chu City (TW); Chih-Chang Cheu, Hsin-Chu City (TW); Chun-Cheng Chang, Hsin-Chu City (TW); Chung-Ming Chen, Hsin-Chu City (TW); Chien-Chang Wu, Hsin-Chu City (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/339,575

(22) Filed: Jan. 26, 2006

(30) Foreign Application Priority Data
Jan. 28, 2005 (TW) 94102667

(51) Int. Cl. G11B 7/00

(52) U.S. Cl. 369/53.1; 369/124.01; 369/59.1

(57) ABSTRACT

A method for compensating frequency response of an actuator in an optical disc drive is provided. The present invention utilizes the temperature sensor within the optical pick-up head to sense work temperature. When the work temperature rises to a presetting threshold value, the servo system will induce the appropriated equalizer to compensate the frequency response of the actuator according to this work temperature, such that the servo controlling of the optical disc drive can operate accurately both in the high temperature condition and in the low temperature condition.

### BACKGROUND OF THE INVENTION

1. Field of the Invention

The present invention generally relates to a method for compensating the frequency response of an actuator of an optical pick-up head, and more particularly to an equalization design for compensating the frequency response of the actuator that corresponds to the work temperature to conform with the controlling requirement of a servo system.

2. Description of the Prior Art

Following the personal computer is developing quickly, the peripheral products is also developing quickly. Especially for the new generation optical disc drive, which has higher operation speed to accomplish the requirement for storing or transferring data is more popular in the storage market at present.

However, when optical disc drive performs a read/write process, the power consumption induced by the high-speed rotating motor, IC with a higher frequency and the several mechanical elements will raise the work temperature of an optical disc drive. In the higher work temperature environment, the optical disc drive is in an unstable condition causing incorrect data access of the optical disc drive.

Further, the optical disc drive includes an actuator and a lens within an optical pick-up head. The actuator is utilized to control the focusing and tracking position of the lens of the pick-up head, and the frequency response of the actuator would be changed according to the various temperatures. If the behavior of the frequency response is different at different temperature, the actuator cannot control accurately the focusing and tracking of the lens, so that the servo controlling of the optical pick-up head would be affected.

In the conventional technology of the optical disc drive, in order to improve the drawback for abovementioned, the method is to add a heat dissipation device such as fan within the optical disc drive to increase the air convection inside the optical disc drive to decrease the work temperature. Nevertheless, the heat dissipation also increased the power consumed of the optical disc drive, and the cost of the optical drive disc. Further, the frequency response of the actuator also cannot be controlled accurately at higher temperature. Therefore, it is important to control the actuator to provide a suitable frequency response at higher temperature environment to maintain the stability of the optical pick-up head.

### SUMMARY OF THE INVENTION

According to the prior art, the present invention provides a method for compensating the frequency response of an actuator to solve the problem of the unstable frequency response in the higher temperature environment. The present invention utilizes the temperature sensor to sense the work temperature, and the servo system provides an equalization design to an equalizer, such that the frequency response of the actuator can be fit in with the controlling design requirement of the servo system. Moreover, the optical pick-up head would not be affected by the frequency response decay of the actuator to affect the controlling quality of the servo system when the optical pick-up head is performed in a higher temperature environment.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a flow diagram showing the steps for compensating the frequency response of the actuator in accordance with the present invention disclosed herein;

FIG. 2 is a schematic representation of the method for compensating the frequency response of the actuator for the optical disc drive in accordance with the present invention disclosed herein; and

FIG. 3 is a diagram of the frequency response of the actuator in accordance with the present invention disclosed herein.

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

The present invention provides a method for compensating frequency response of an actuator. The major of the method is to utilize the temperature sensor such as thermistor to monitor the work temperature. When the work temperature is raised to over a presetting threshold value, the optical pick-up head will provide a suitable equalization design to compensate the frequency response of the actuator according to the raised work temperature. Thus, the frequency response of the actuator can fit in with the requirement of the optical disc drive servo system. On the other hand, the optical pick-up head still performs the servo controlling accurately in the higher temperature environment.

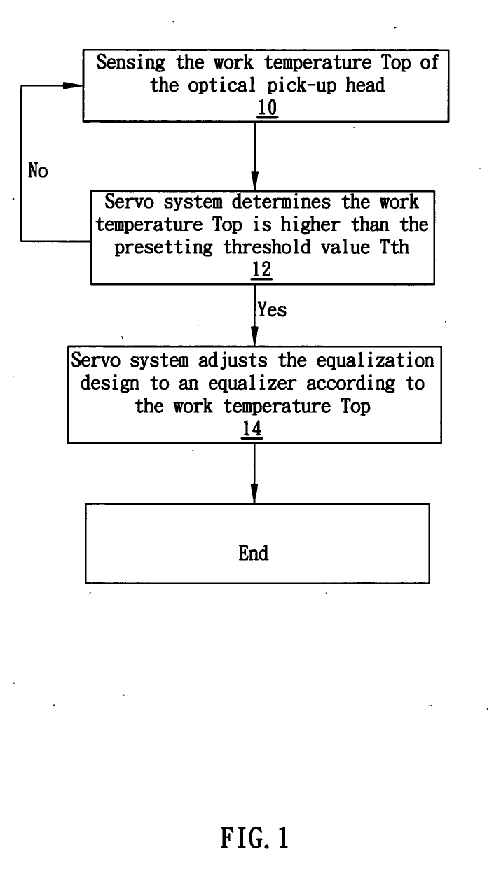

Please referring to FIG. 1, shows a flow chart for compensating the frequency response of the actuator of the present invention.

First, the step 10 denotes the temperature sensor to sense the work temperature Tₒₚ inside the optical pick-up head. The work temperature Tₒₚ is transferred to the servo system of the optical disc drive to determine in subsequently process. Step 12 denotes that servo system determines the work temperature Tₒₚ is higher than a presetting threshold values Tₜₕ. If it is, the process is performed the step 14, else, the process is returned to the step 10.

Then, the step 14 denotes that the servo system determined the work temperature Tₒₚ is higher than the presetting threshold value Tₜₕ, the servo system will adjust the equalization design according to the work temperature Tₒₚ, such that the frequency response of the actuator can fit in with the requirement of the servo system after the equalization design is adjusted.

Because of the conventional servo system of the optical disc drive utilizes a unique equalizer to compensate the frequency response of the actuator of the optical pick-up head. The purpose of the equalizer is to let the servo system to work with several requirements in the general case. For example, these requirements can be gain margin, the phase margin, or the bandwidth. For the instance of the focusing servo controlling, in order to suit the requirement of the defect and the shock of the optical disc drive, the optical pick-up head has different gain cross-over frequency according to different operation speed.

Therefore, according to the step 14, the adjusted equalization design at higher temperature may let the actuator not be affected and the servo system can normally control the actuator between the high temperature and the normal temperature. That is to say, the optical pick-up head can obtain a better servo control.

In this embodiment, when the work temperature Tₒₚ of the optical pick-up head is over a presetting threshold value Tₜₕ, another equalization design for compensating the frequency response of the actuator to fit in with the controlling requirement of the servo system is used. In another embodiment is to build a look-up table. The look-up table is used for the work temperature and the suitable equalization design of the equalizer. When the work temperature Tₒₚ of the optical pick-up head is over the presetting threshold value Tₜₕ, the optical pick-up head will provide a suitable equalization design for the actuator at this work temperature Tₒₚ.

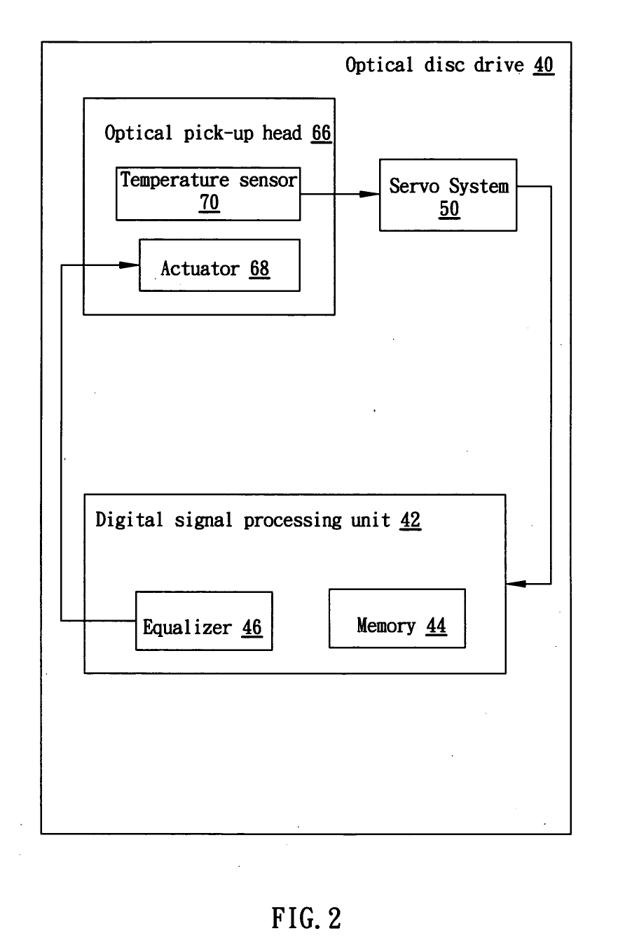

Referring to FIG. 2, show the diagram of the method for compensating the frequency response of the actuator of the optical disc drive. The optical disc drive 40 includes an interface controlling unit (not show in figure), a digital signal processing unit 42, an optical pick-up head 66, and the servo system 50.

The interface controlling unit used to receive the commands, such as read/write data from the processing host, and controlling the servo system 50 in subsequently process.

The servo system 50 controls the focusing and the tracking of the optical pick-up head 66 after receiving the commands from the interface controlling unit.

The digital signal processing unit includes a memory 44 and the equalizer 46. The major function of the digital signal processing unit is used to process the encoded/decoded of the read/write data, and to provide the frequency response for the equalizer to compensate the actuator 46.

The optical pick-up head 66 used to emit the laser, and the optical pick-up head 66 includes an actuator 68 and a temperature sensor 70. The actuator 68 used to drive the lens of the optical pick-up head to move along the disc direction, or move toward the radial direction of the optical disc drive, wherein the actuator 68 includes a voice coil motor (not shown in figure). The voice coil motor used to adjust the vertical position of the lens of the optical pick-up head 66, such that the laser of the optical pick-up head 66 can focus on the compact disc accurately.

Furthermore, the temperature sensor 70, such as thermistor, inside the optical pick-up head 66 to sense the work temperature Tₒₚ of the optical pick-up head 66. When the servo system 50 determines that the work temperature Tₒₚ of the optical pick-up head 66 is higher than a presetting threshold value Tₜₕ, the servo system 50 will accord the work temperature Tₒₚ to find out a suitable equalization design from a temperature-equalization design look-up table, wherein this look-up table is stored in the memory 44. Thus, the equalizer 46 can compensate the actuator according to the equalization design. Thus, no matter what the optical pick-up head 66 is performed at high temperature or at low temperature, the actuator can obtain the better frequency compensation, and the optical pick-up head 66 also can obtain the better servo control.

In another embodiment, it is design for simplifying the servo system 50. When the work temperature Tₒₚ of the optical pick-up head 66 is higher than the presetting threshold value, the servo system 50 will use another equalization design to compensate the frequency response of the actuator 68. If the work temperature Tₒₚ of the optical pick-up head is not over the presetting threshold value Tₜₕ, the servo system 50 will adopt the presetting equalization design. Also, the optical pick-up head 66 can obtain the better servo control.

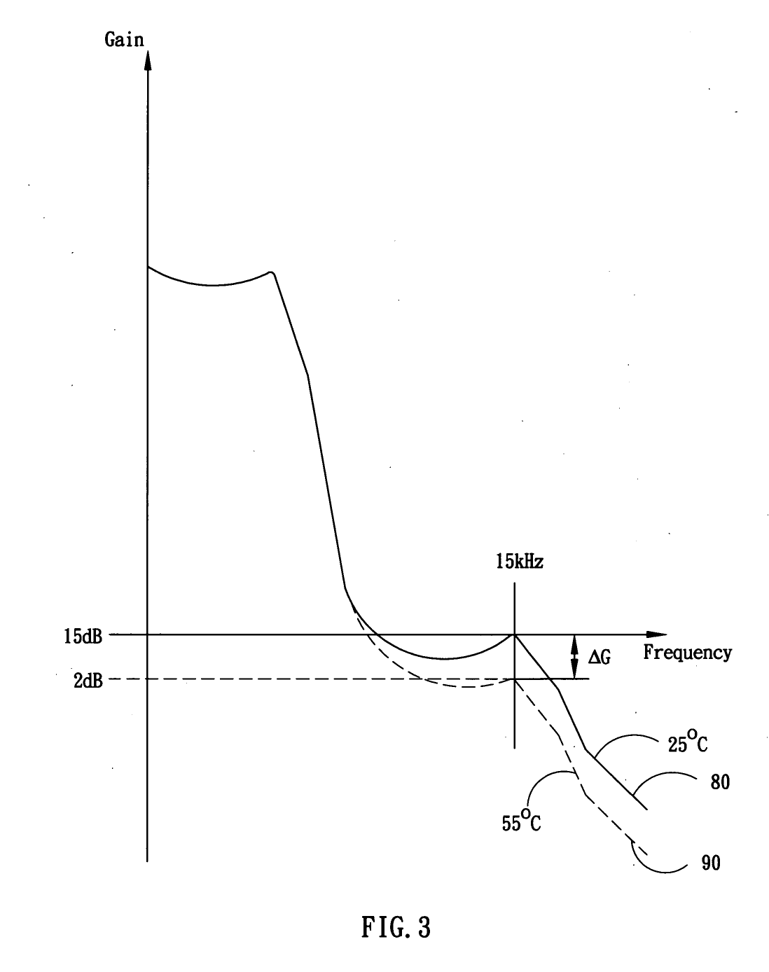

Next, referring to FIG. 3, which show the diagram of the frequency response of the actuator 68. Herein, the real line 80 and the dotted line 90 illustrate the compensating method for the different temperatures correspond to the different frequency response respectively, wherein the real line 80 illustrates the frequency response curve of the actuator 68 that corresponds to temperature at 25° C.; and the dotted line 90 illustrates the frequency response curve of the actuator 68 that corresponds to the temperature at 55° C. FIG. 3 shows the frequency response of the actuator 68 that will change following the different temperature, and the curve diagram of the gain value also can be obtained that corresponding to the different temperature.

When the actuator 69 drives the optical pick-up head 66 to move at frequency is 15 kHz, and the temperature at 25° C., the gain value of the work frequency 15 kHz is 15 dB. Because of the controlling gain margin boundary of the servo system 50 must be large than 6 dB, so that the compensated frequency response for the equalization design must be fit in with the requirement of the controlling design of the servo system 50. However, comparing the operation at 55° C. and 15 kHz with the normal temperature at 25° C., the gain value is decay to 2 dB, thus, the gain value cannot fit in with the controlling design requirement of the servo system 50, such that the optical pick-up head 66 cannot performed the focusing and seeking on the compact disc accurately, and the optical pick-up head 66 may be shaken to lose the focusing when the optical pick-up head 66 read/write data on the compact disc.

Thus, the servo system 50 adopted another equalization design when the temperature at 55° C., such that the equalizer can compensate the actuator on this equalization design condition, and the gain value can increase to fit in with the controlling design requirement of the servo system 50.

Therefore, the advantage of the present invention is that the frequency response can be compensated at higher temperature, such that the frequency response of the actuator can fit in with the controlling design requirement of the servo system at high temperature or low temperature. Because of the present invention utilizes the presetting equalization design to compensate the frequency response of the actuator at a normal temperature; and the servo system will control the equalizer to adopt another optima equalization design which differs from the presetting equalization design that according to the work temperature which is sensed by the temperature sensor of the optical pick-up head. Thus, the frequency response of the actuator can fit in with the controlling design requirement of the servo system when operating at a higher temperature or at normal temperature.

Although specific embodiments have been illustrated and described, it will be obvious to those skilled in the art that various modifications may be made without departing from what is intended to be limited solely by the appended claims.

What is claimed is:

1. A method for compensating frequency response of an actuator in an optical disc drive, said method comprising:
sensing a work temperature of an optical pick-up head;
determining said work temperature being higher than a presetting threshold value; and
providing an equalization design to compensate a frequency response of said actuator according to said work temperature.

2. The method according to claim 1, wherein said providing a presetting equalization design to compensate said frequency response of said actuator if said work temperature is lower than said presetting threshold value.

3. The method according to claim 1, wherein the device of said sensing said work temperature is a temperature sensor.

4. The method according to claim 1, wherein the device of said compensate said frequency response is an equalizer.

5. An optical disc drive having a compensable frequency response of an actuator, said optical disc drive comprising:
an optical pick-up head, said optical pick-up head having a temperature sensor, a lens and an actuator, used to read/write data to a compact disc, said temperature sensor used to sense a work temperature of said optical pick-up head, and said actuator having a plurality of voice coil motors used to drive said lens to move toward or backward along the compact disc or moved along the radial direction of said compact disc;
a digital signal processing unit, said digital signal processing unit having a memory and a set of equalization designs used to process encoded/decoded of the data, and compensated a frequency response of said actuator by using said set of equalization designs; and
a servo system, said servo system determined said work temperature being higher than a presetting threshold value, said frequency response applied for a controlling design requirement of said servo system that according to said work temperature to provide a specific equalization design from said set of equalization designs.

6. The optical disc drive according to claim 5, wherein said servo system correspond to a look-up table for a work temperature and a suitable equalization design to obtain said specific equalization design from said work temperature.

7. The optical disc drive according to claim 5, wherein said controlling design requirement comprises a bandwidth, gain margin, or a phase margin.
